(19) United States
(12) Patent Application Publication
(10) Pub. No.: US 2011/0251936 A1
(43) Pub. Date: Oct. 13, 2011

(54) Method for Selecting a Charging Rule in Connection with a Subscriber and System Thereof

(75) Inventors: Wenlin ZHANG, Shenzhen (CN); Xiaoqin DUAN, Shenzhen (CN); Yajuan WU, Shenzhen (CN)

(73) Assignee: Huawei Technologies Co., Ltd., Shenzhen (CN)

(21) Appl. No.: 13/163,272

(22) Filed: Jun. 17, 2011

Related U.S. Application Data
(63) Continuation of application No. 11/542,214, filed on Oct. 4, 2006, now abandoned.

(30) Foreign Application Priority Data
May 12, 2004 (CN) 200410044425.9

(51) Int. Cl. G06Q 30/00

(52) U.S. Cl. 705/30

(57) ABSTRACT

The present invention discloses a method for selecting a charging rule in connection with a subscriber. The method comprises: an AF providing a CRF with service information and user information used for selecting a charging rule; the CRF selecting a charging rule for the subscriber according to the user information and service information. The present invention also provides a system for selecting a charging rule in connection with subscriber. By this invention, the CRF, when selecting a charging rule, can select a charging rule in connection with different subscribers according to the user information and implement diversified charging based on different using situations of the same packet data service, which will attract subscribers to use packet data service, increase the using frequency of packet data service, and be conducive to the promotion and application of packet data service.

This application is a continuation of U.S. patent application Ser. No. 11/542,214, entitled “Method for selecting a charging rule in connection with a subscriber and system thereof,” filed on Oct. 4, 2006, which application is hereby incorporated herein by reference.

This application claims priority to Chinese Patent Application 200410044425.9, which was filed May 12, 2004 and is incorporated herein by reference.

### TECHNICAL FIELD

The present invention relates to the field of charging for packet data, and more particularly to a method for selecting a charging rule in connection with subscriber and a system thereof.

### BACKGROUND

Along with the increasing applications of packet data service, it has become a common concern of operators to charge for packet data service accurately and reasonably.

In the present charging system of all packet-switch based network, for example, the General Packet Radio Service (GPRS) network, since service data flow based on a terminal can only be differentiated down to the level identified by an Access Point Name (APN) and charging information is colleted per Packet Data Protocol (PDP) Context, it is only possible to charge according to the APN and the PDP Context. In practical terms, however, a plurality of parallel service data flows may likely be borne in one PDP Context, for which it may be necessary to charge in different charging modes. This is a requirement the present GPRS charging system can not satisfy. For example, a packet streaming service and a multi-media messaging service may be carried through a terminal at the same time and the two services are born in one PDP Context to the same APN at the same time. The charging rules for the two services, however, may be different as the packet streaming service needs to be charged based on the data volume received on the terminal or the time duration of the service while the multi-media messaging service needs to be charged based on an event, which may be sending or receiving a multi-media message. In order to charge for packet-switch based data services of different types by the same approach, it is necessary to put forward a new charging architecture for all the packet-switch based charging system and to adopt a universal charging mechanism based on service data flow.

In view of the above, the 3rd Generation Partnership Project (3GPP) is discussing the implementation of Flow Based Charging (FBC) based on Internet Protocol (IP). In terms of a packet data service, the data volume or time consumed by the terminal when using the service is referred to as Service Data Flow, which aggregates set of packet flows. A plurality of different packet data service flows can be borne in one PDP Context to one APN. Thus, the charging granularity based on service data flow is far detailed than the charging granularity based on a PDP Context. As charging based on service data flow gives a more actual reflection of the resources occupied by a certain service data flow, it provides the operator or service provider with more flexible approaches to charge for the services.

The system architecture, functional specifications, and message interactive processes of FBC have been described in 3GPP. FIG. 1A shows an FBC system architecture for on-line charging, where Service Control Point (SCP) 101 of Customized Application for Mobile Network Enhanced Logic (CAMEL) and Service Data Flow Based Credit Control Function (CC) 102 constitute Online Charging System (OCS) 106. CC 102 is connected with Service Data Flow Based Charging Rule Function (CRF) 103 via interface Ry, CRF 103 is connected with Application Function (AF) 104 via interface Rx, CRF 103 is connected with Traffic Plane Function (TPF) 105 via interface Gx, and CC 102 is connected with TPF 105 via interface Gy.

The FBC system architecture supporting off-line charging is shown as FIG. 1B, where CRF 103 is connected with AF 104 via Rx, CRF 103 is connected with TPF 105 via Gx, and TPF 105 is connected via interface Gz with Charging Gateway Function (CGF) 107 and Charging Collection Function (CCF) 108, respectively.

The functions implemented by each functional entity are described below in accordance with the current definitions of FBC functional entities in 3GPP.

TPF 105 is the functional entity for bearing service data flow, being able to differentiate data packets belonging to different processes of packet data service and used for collecting off-line charging information and performing on-line credit control. When the bearer of a service data flow changes, for example, in the processes of bearer creating, bearer modifying, and bearer deleting, TPF 105 will request a charging rule from CRF 103 via Gx and the message requesting a charging rule may carry relevant information of the terminal, features of the bearer as well as information related with the network, where relevant information of the terminal may comprise the international number of Mobile Station Integrated Service Data Network (MSISDN), the International Mobile Subscriber Identity (IMSI), and etc, relevant information on features of bearer may comprise parameters of Quality of Service (QoS), and information related with the network may comprise the Mobile Network Code (MNC), Mobile Country Code (MCC), and etc. TPF 105 performs packet data filtering and charging-information collecting on the corresponding service data flow in accordance with the charging rule returned by CRF 103. One TPF 105 can be served by one or multiple CRF 103, and when one TPF 105 is served by multiple CRFs 103, an appropriate CRF 103 can be selected according to the terminal identification for interaction with TPF 105. TPF 105 supports predefined charging rules and predefined service data flow filters.

CRF 103 is the functional entity for storing charging rules, supporting dynamic and static charging rules. A dynamic charging rule refers to a rule generated in real-time time in accordance with the charging policy of a packet data service and applied to the corresponding service data flow; a static charging rule refers to a rule that does not change in the process while the terminal is using a packet data service and can be activated dynamically by some events during the process when the terminal is using a packet data service. CRF 103 can select appropriate charging rules in accordance with the information provided by TPF 105, and/or AF 104, and/or OCS 106, and provide the selected charging rule for TPF 105 when TPF 105 requests a charging rule from it or a specific event has occurred. One CRF 103 may correspond to multiple TPF 105.

AF 104 represents all functional entities associated with application. AF 104 may be a network entity of the operator itself, or a network entity of a third-party service provider. AF 104 provides CRF 103 with appropriate information related with service and application, based on which CRF 103 can select or configure appropriate charging rules. One AF 104 may correspond to more than one CRF 103, and when more than one CRF 103 corresponds to one AF 104, an appropriate CRF 103 can be selected according to the terminal identification for interaction with AF 104.

CC 102 is the functional entity for performing credit control, which is used only in online charging system and can be implemented by adding a new function to the existing OCS 106. CC 102 in OCS 106 can provide CRF 103 via interface Ry with relevant online charging information for use in selecting a charging rule.

CGF 107/CCF 108 is the functional entity for off-line charging system and can be implemented with approaches in the present packet-switched data charging system.

If the bearer network is a GPRS network, TPF 105 will be a Gateway GPRS Support Node (GGSN), AF 104 will be an application proxy or an application server in a Packet Data Network (PDN). When an IP Multimedia Subsystem (IMS) is borne on a GPRS network, AF 104 will be a Proxy Call Session Control Function (P-CSCF) entity, CRF 103 will be a newly-added logic entity.

The above mentioned charging architecture and functions implemented by each functional entity are also applicable to the network architecture of 3GPP2.

In the existing charging systems based on the FBC mechanism, AF 104 and CRF 103 are connected via Rx interface. That is why CRF 103 can select appropriate charging rules or configure some parameters for charging rules based on some application-relevant information provided by AF 104. The operator can determine which data from AF 104 can be used in selecting a charging rule when configuring a charging rule in CRF 103. At present, the information which AF 104 provides for CRF 103 includes: identity information of a service data flow, which can identify the aggregate set of IP flows through using wildcard; information for use in selecting a charging rule, including application/service identification, events for triggering an application/service charging rule, type of a service data flow, and rate of a service data flow. The identity information of a service data flow can support wildcard, and type of a service data flow can be audio, video, and etc., which is an optional parameter, and so is the rate of a service data flow.

### SUMMARY OF THE INVENTION

A method for selecting a charging rule in connection with subscriber comprises:

an Application Function (AF) providing a Charging Rule Function (CRF) with service information and user information used for selecting a charging rule;

the CRF selecting a charging rule for a subscriber according to the user information and service information.

A system for selecting a charging rule in connection with a subscriber comprises an Application Function (AF) and a Charging Rule Function (CRF); wherein,

the AF provides the CRF with service information and user information used for selecting a charging rule;

the CRF selects the charging rule for the subscriber according to the user information and service information.

A system for selecting a charging rule in connection with a subscriber comprises an Application Function (AF), an agent Charging Rule Function (CRF) of the subscriber and an home CRF of the subscriber; wherein,

the AF provides the agent CRF with service information and user information used for selecting the charging rule;

the agent CRF forwards the service information and the user information to the home CRF of the subscriber;

the home CRF of the subscriber selects the charging rule for the subscriber according to the user information and service information.

As seen from the above-mentioned scheme, the AF provides the CRF with the user information as well as the service information such that the CRF can select a charging rule in connection with the subscriber according to the user information, that is, differentiated charging can be implemented in accordance with different ways of using a same packet data service, thus attracting subscribers of packet data services, increasing the frequency of use thereof, and promoting the spread of packet data services.

When a subscriber is roaming, if the AF currently accessed by the subscriber and the home CRF of the subscriber are not the same one, it will be necessary in the selection of a charging rule that the AF forward the information to the home CRF of the subscriber via another CRF. In this case, as the AF has provided the other CRF with the user information as well as the service information, the other CRF will be able to address the home CRF of the subscriber according to the user information, and further, forward to the home CRF of the subscriber the service information for use in selecting a charging rule so that the home CRF can select a charging rule in connection with a roaming subscriber. In addition, the implementation of this invention will have no impact on existing charging modes in a PLMN due to good compatibility.

### BRIEF DESCRIPTION OF THE DRAWINGS

FIG. 1A is a schematic diagram for the structure of the on-line FBC system. FIG. 1;

FIG. 1B is a schematic diagram for the structure of the off-line FBC system.

FIG. 2 is a schematic diagram of the process during which the AF provides the service information and user information for the CRF in accordance with an embodiment of the present invention.

FIG. 3 is a schematic diagram of the implementation process in accordance with an embodiment of the present invention.

FIG. 4 is a schematic diagram of the implementation process when the subscriber is roaming in accordance with the present invention.

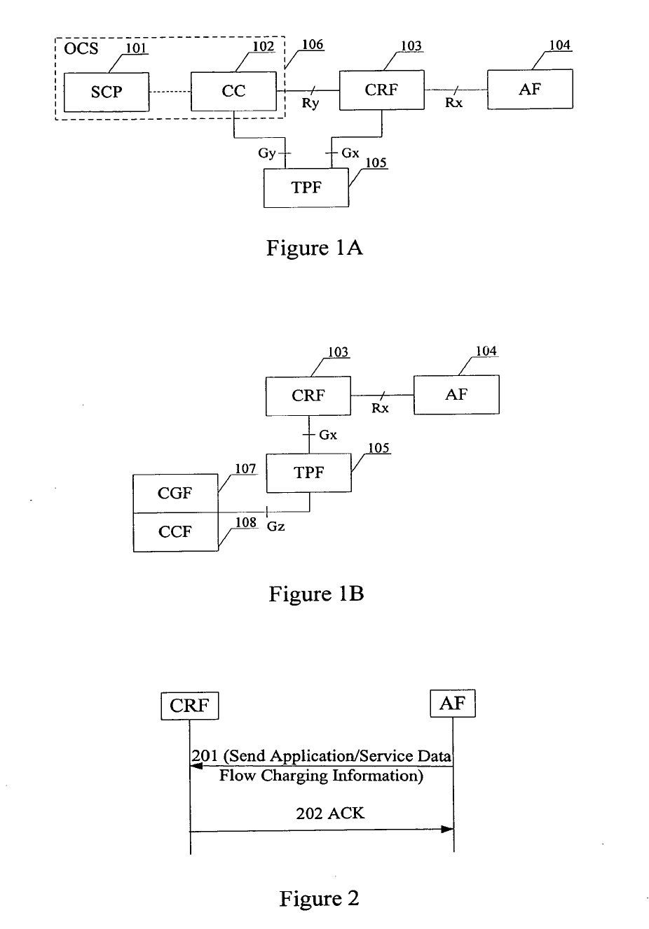

### DETAILED DESCRIPTION OF ILLUSTRATIVE EMBODIMENTS

The invention is hereinafter further described in detail with reference to the accompanying drawings in order to give a clearer picture of the object, technical solution and advantages of this invention.

According to this invention, an AF provides a CRF with user information as well as service information such that the CRF will be able to choose a charging rule in connection with the subscriber according to the user information. The user information comprises a user identification, which may be in the format of subscriber terminal identification, for identifying different independent subscribers; or group identification for identifying different user groups consisting of one or more subscribers. Group identification may be a logical one and a user group may be defined on the basis of applications of packet data service or by a rule provided by the operator. The corresponding relationship between user identification and group identification may be stored in the CRF or in other functional entities of PLMN. The user information may also comprise a combination of user identification and group identification for identifying different subscribers in a certain group, or different subscribers in different groups.

FIG. 2 is a schematic diagram illustrating the process in which the AF provides service information and user information for the CRF. As shown in FIG. 2, the specific process in which the AF provides service information and user information for the CRF comprises the steps of:

Step 201: The AF sends to the CRF Application/Service Data Flow Charging

Information, which contains service information and user information. The service information may comprise application/service identification, trigger event of application/service charging rule, type of service data flow, and rate of service data flow.

Step 202: Upon receiving the application/service information, the CRF returns an ACK message to the AF to notify the AF of having received the application/service information sent by the AF.

In the subsequent operation, if the CRF which receives the application/service information is the home CRF of the subscriber, this CRF will choose an appropriate charging rule for the subscriber according to the user information and service information and send to the TPF the charging rule finally selected. Upon receiving the charging rule, the TPF performs charging for the corresponding service data flow according to the selected charging rule. If the CRF which receives the application/service information is not the home CRF of the subscriber, this CRF will find the home CRF of the subscriber according to the user information and send to the home CRF of the subscriber the service information and user information provided by the AF. Upon receiving the information, the home CRF will select for the corresponding subscriber an appropriate charging rule according to the user information and service information and then send the selected charging rule to the TPF. Upon receiving the charging rule, TPF will perform charging for the corresponding service data flow according to the selected charging rule.

The user information may comprise one or more user identifications for identifying one or more independent subscribers, or one or more group identifications for identifying one or more groups, or a combination of one or more user identifications and one group identification for identifying one or more independent subscribers in a group, or a combination of a plurality of user identifications and one group identification for identifying different subscribers in a certain group, or a combination of a plurality of user identifications and a plurality of group identifications for identifying different independent subscribers in different groups. In addition, the user information may be null for use in requesting the CRF to select the same charging rule for all subscribers. The number of user identifications, group identifications or combinations of user identification and group identification can be set based on specific applications or the desire of the operator.

In this way, if the AF wishes to implement a specific charging rule for a subscriber or group, it can provide the user information comprising user identification, or group identification, or combination of user identification and group identification for the CRF, which will select a charging rule in connection with the subscriber or group, thus diversified charging can be implemented.

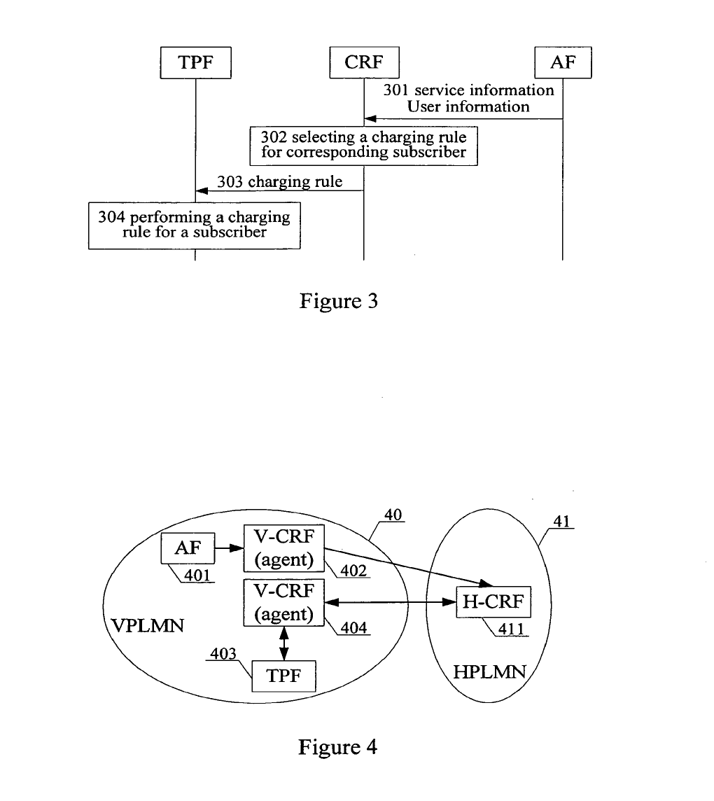

FIG. 3 is a schematic diagram of the implementing process of this invention. As shown in FIG. 3, when the AF is located in the same PLMN as the home CRF of the subscriber, the CRF mentioned below is the home CRF of the subscriber. The implementation of selecting a charging rule in connection with the subscriber comprises the steps of:

Steps 301˜302: The AF provides the CRF with the service information and user information. The CRF selects an appropriate charging rule for the corresponding subscriber according to the user information and service information received.

Steps 303˜304: The CRF sends the selected charging rule to the TPF. Upon receiving the charging rule, the TPF performs the charging rule for the corresponding service data flow in connection with the corresponding subscriber.

The invention is further described below by examples of application with reference to FIG. 3.

The first example: the AF is the application server of an Internet Service Provider (ISP) providing on-line game service, and the subscribers are charged in different rates according to different levels of each subscriber in the on-line game. For instance, a subscriber with 10,000 credits would be given a 50% discount of the charging rate and a subscriber with 5,000 credits would enjoy 20% discount. A preferential charging policy will be applied to any subscriber who has acquired the amount of credits set in advance as long as she/he continues to use the on-line game service provided by the application server. Thus, it is necessary to modify the charging rule performed on that subscriber when her/his credits have reached 10,000. The specific implementation comprises the steps of:

Steps 301A˜302A: There is information about the subscriber's credit stored in AF, so when the subscriber's credits accumulated have reached 10,000, AF will send Application/Service Data Flow Charging Information to the CRF to inform the CRF that the specific subscriber should be charged with a new charging rule. Said Application/Service Data Flow Charging Information includes the service information and the subscriber identification. The service information may comprise: service data flow identification for identifying the service data flow on which a new charging rule needs to be performed, the AF application identification for identifying the modification to the charging rule for the on-line game service, and the trigger event of application/service charging rules for indicating that the charging rate is to be modified to 50% of the rate. The subscriber identification is for indicating that the new rule is to be applied only to the identified subscriber. Upon receiving the Application/Service Data Flow Charging Information, the CRF will select an appropriate charging rule for the subscriber according to the user identification and service information as well as the information from the TPF. The charging rate in this selected charging rule will be 50% of the original rate.

Steps 303A˜304A: the CRF sends to the TPF the selected charging rule. Upon receiving the rule, the TPF makes appropriate operations on the received charging rule, for instance, creating a new charging rule, deleting the original charging rule, or modifying the original charging rule. Then the TPF will perform the charging rule on the corresponding service data flow in connection with the subscriber.

It can be seen from the above that charging subscribers of high credits with preferential charging rates can attract not only subscribers of high credits to continue to use the packet data service but also other subscribers to have more access to this service so as to be given a preferential charging rate, thus promoting the packet data service, in this case, the on-line game service.

The second example: The operator is promoting the application of packet data service in subscribers of a group. In the promotion period, all subscribers of the group can be given a 20% discount of the charging rate when using the on-line network service provided by the operator. Thus, it is necessary to modify the charging rule performed on the subscribers of the group at the beginning of the promotion period. The specific implementation comprises the steps of:

Steps 301B˜302B: The AF in charge of on-line services in the operator's network provides the service information and group identification for the CRF. The service information includes the service data flow identification with wildcard for identifying all service data flows on which new charging rules are to be performed, the AF application identification for indicating that the modification is made to the charging rules for on-line services, the trigger event of application/service charging rules for indicating that the charging rate is to be modified to 80% thereof, and the group identification for indicating the new charging rule is to be performed only on the group subscriber. Upon receiving the service information and group identification, the CRF will select an appropriate charging rule for the group subscriber according to the group identification and service information as well as the information from the TPF. The charging rate in this charging rule is 80% of the original rate.

Steps 303B˜304B: The CRF sends the selected charging rule to the TPF. Upon receiving the charging rule, the TPF makes appropriate operations on the received rule, for instance, creating a new charging rule, deleting the original charging rule, or modifying the original charging rule. Then the TPF performs the charging rule on the corresponding service data flow in connection with the subscribers of the corresponding group.

The group identification mentioned above can identify one or more groups, for instance, with one specific group identification identifying one group and a wildcard identification identifying a plurality of groups; and can identify all the groups, for instance, when the group identification is set as 0 (zero), it identifies all groups.

In addition, it is possible to perform a preferential charging rule on one or more subscribers in the group. Then the AF needs to provide the CRF with the user identification along with the group identification to indicate that one or more the subscribers of the group should be charged with a preferential charging policy, or those different subscribers in different groups should be charged with a preferential charging policy.

At the end of the promotion period, the charging rate can be modified to the original rate by the above procedures to stop charging the group subscriber with a preferential charging policy.

FIG. 4 is a schematic diagram of the implementing process of this invention when the subscriber is roaming. As shown in FIG. 4, AF 401 currently used by a subscriber is located in a different PLMN from the PLMN where the home CRF (H-CRF) 411 of the subscriber is located. The subscriber is using TPF 403 and AF 401 in PLMN (VPLMN) 40 which is currently accessed by the subscriber. V-CRF 402 is configured for AF 401 as an agent CRF to provide service for subscribers whose home PLMN is other than the currently accessed one. The specific implementation of selecting a charging rule in connection with a roaming subscriber comprises the steps of:

Step A1: AF 401 receives the packet data service request sent from a subscriber and decides that the home PLMN of the subscriber is not PLMN 40 according to the user information, for instance, the user identification. Then AF 401 sends to V-CRF 402 which is configured in advance for AF 401 as an agent CRF the Application/Service Data Flow Charging Information used for selecting a charging rule, which includes the service information and user information. If AF 401 determines according to the user identification that the home PLMN of the subscriber is PLMN 40, AF 401 will send directly to the home CRF of the subscriber the Application/Service Data Flow Charging Information used for selecting a charging rule.

Step A2: Upon receiving the Application/Service Data Flow Charging Information, V-CRF 402 determines according to the user information that the home PLMN of the subscriber is PLMN 41 and then forwards the Application/Service Data Flow Charging Information used for selecting a charging rule to H-CRF 411 in PLMN 41. Upon receiving the Application/Service Data Flow Charging Information provided by AF 401, H-CRF 411 selects an appropriate charging rule for the corresponding subscriber based on the user information and service information contained in the Application/Service Data Flow Charging Information.

If the TPF currently used by the subscriber is in the same PLMN as H-CRF 411 of the subscriber, that is, both TPF and H-CRF 411 are located in HPLMN 41, H-CRF 411 will send directly to TPF the selected charging rule. Upon receiving the charging rule, TPF performs the charging rule on the corresponding service data flow in connection with the subscriber. If TPF 403 currently used by the subscriber is located in a different PLMN from H-CRF 411 of the subscriber, as shown in FIG. 4, Visited CRF (V-CRF) 404 is configured for TPF 403 as an agent CRF providing service for subscribers whose home PLMN is other than this, and the subsequent procedure comprises the step of:

Step A3: After selecting a charging rule for the corresponding subscriber, H-CRF 411 sends to V-CRF 404 the selected charging rule. Upon receiving the selected charging rule provided by H-CRF 411, V-CRF 404 may make proper modification to the charging rule provided by H-CRF 411 according to the charging policy of VPLMN 40 to create a new charging rule, and then sends the created charging rule to TPF 403. Upon receiving the created charging rule, TPF 403 performs the created charging rule on the corresponding service data flow in connection with the subscriber.

The step of the CRF selecting a charging rule as mentioned above may comprise: the CRF selecting a certain charging rule among the existing charging rules, which are configured in advance by the operator and have been stored in CRF, or the CRF modifying the configuration parameters of the existing charging rules to create new charging rules, or the CRF creating new charging rules by configuring whole new parameters.

It is appreciated that the above description is only preferred embodiments of this invention and not to be construed as limits to the protection scope of the invention.

What is claimed is:

1. A method in a charging system of flow based charging rule selection for selecting a charging rule in connection with a subscriber, the method comprising:
providing, by an Application Function (AF) entity in a communication network, a Charging Rule Function (CRF) entity in the communication network with service information and user information used for selecting a charging rule for a subscriber, wherein the service information provided by the AF comprises application/service identification, trigger event of application/service charging rule, the user information provided by the AF is a user identification, a group identification or a combination of user identification and group identification;
selecting, by the CRF, a charging rule for the subscriber according to the user information and service information of the subscriber.

2. The method of claim 1, wherein the combination of user identification and group identification is a combination of one or more user identifications and one group identification, or a combination of more than one user identification and more than one group identification.

3. The method of claim 1, further comprising:
sending, by the CRF, the selected charging rule to a Traffic Plane Function (TPF) entity in the communication network; and
performing, by the TPF, appropriate operation based on the received charging rule, wherein the appropriate operation comprises one or more of a charging rule creation, a charging rule deletion, and a charging rule modification.

4. The method of claim 3, further comprising:
performing, by the TPF, the charging rule on a corresponding service data flow in connection with the subscriber.

5. The method according to claim 3, wherein if the TPF is located in a Visited Public Land Mobile Network (V-PLMN) which is different from a home PLMN (H-PLMN) of the subscriber, the step of sending by the CRF the selected charging rule to a TPF comprises:
providing, by a home CRF (H-CRF) in the H-PLMN of the subscriber, the selected charging rule to a visited CRF (V-CRF) in the V-PLMN; and
sending, by the V-CRF, the charging rule to the TPF.

6. The method of claim 1, wherein the step of selecting by the CRF a charging rule comprises one of the following actions:
selecting, by the CRF, an appropriate charging rule from pre-configured charging rules which are configured in advance by an operator in the CRF;
modifying the configure parameters of a pre-configured charging rule to form the selected charging rule;
creating the selected charging rule by configuring parameter for the charging rule.

7. The method of claim 1, wherein,
the step of providing a CRF with service information and user information comprises:
providing, by the AF in a visited Public Land Mobile Network (V-PLMN) which is currently accessed by the subscriber, an agent CRF configured for the AF in the V-PLMN with the service information and the user information;
forwarding, by the agent CRF, to a home CRF in a home PLMN of the subscriber the service information and the user information, and
the step of selecting by a CRF a charging rule for a subscriber according to the user information and service information comprises:
selecting, by the home CRF of the subscriber, the charging rule for the subscriber according to the user information and service information.

8. The method of claim 7, further comprising before the AF providing the agent CRF with the service information and the user information:
deciding, by the AF based on the user information, that the home PLMN of the subscriber is different from the visited PLMN of the subscriber.

9. The method of claim 1, wherein the step of providing by the AF the CRF with the service information and user information used for selecting the charging rule comprises:
sending by the AF the service information and the user identification to the CRF to inform the CRF that the subscriber should be charged with the charging rule corresponding to a level of the subscriber when the level of the subscriber is changed; and
wherein the step of selecting a charging rule for the subscriber according to the user information and service information comprises: selecting by the CRF the charging rule for the subscriber according to the service information and the user identification.

10. The method of claim 1, wherein the step of providing by the AP the CRF with the service information and user information used for selecting the charging rule comprises:
sending by the AF the service information and the group identification to the CRF informing the CRF that a group subscriber should be charged with a new charging rule; and
wherein the step of selecting the charging rule for the subscriber according to the user information and service information comprises:
selecting by the CRF a new charging rule for the group subscriber according to the service information and the group identification.

11. A flow based charging system for selecting a charging rule for a subscriber, the system comprising:
an Application Function (AF), in the flow based charging system;
a Charging Rule Function (CRF) in the flow based charging system; and
wherein the AF is configured to provide the CRF with service information and user information of a subscriber used for selecting a charging rule for the subscriber, the user information being a user identification, a group identification or a combination of user identification and service identification, the service information comprising application/service identification, trigger event of application/service charging rule, and service data flow identification for identifying a service data flow on which the charging rule to be performed;
wherein the CRF is configured to select a charging rule for the subscriber according to the user information and the service information.

12. The method of claim 11, wherein the combination of user identification and group identification is a combination of one or more user identifications and one group identification, or a combination of more than one user identification and more than one group identification.

13. The system of claim 11, wherein the CRF is further adapted to send the selected charging rule to a Traffic Plane Function (TPF) in the flow based charging system, and wherein the TPF is adapted to perform an appropriate action based on the charging rule, the appropriate operation comprising one or more of a charging rule creation, a charging rule deletion, and a charging rule modification.

14. The system of claim 11, wherein the TPF is further adapted to implement the charging rule on a service data flow of the subscriber.

15. A flow based charging system in a communication network, the system comprising:
a charging rule function (CRF) entity communicatively connected to an application function (AF) entity in the flow based charging system,
wherein CRF entity is adapted to obtain from the AF entity service information and user information used for charging rule selection, and the CRF is adapted to determine a charging rule for the subscriber based on the service information and the user information obtained from the AF.

16. The system of claim 15, wherein the CRF entity resides in a home network of the subscriber and is adapted to obtain the service information and the user information via an agent CRF entity which is located in a visited network that the subscriber is currently accessing, the AF entity residing in the visited network.

17. The system of claim 15, wherein the CRF is further adapted to send the selected charging rule to a traffic plane function (TPF) entity in the flow based charging system so that the TPF performs a corresponding action based on the charging rule.

18. The system of claim 15, wherein the user information obtained by the CRF from the AF comprises a user identification, and the charging rule function entity is configured to determine the charging rule for the subscriber identified by the user identification.

19. The system of claim 15, wherein the obtained user information comprises a group identification, and wherein the CRF entity determines the charging rule for the subscriber(s) of a user group identified by the group identification.

20. The system of claim 15, wherein the obtained user information comprises a combination of user identification and group identification, and the CRF entity is configured to determine the charging rule for the subscriber indicated by the user identification of a user group which is identified by the group identification.

21. A method for selecting a charging rule in a flow based charging system, the method comprising:
obtaining service information used for charging rule selection, the service information being provided by an application function entity, the service information being obtained by a charging rule function (CRF) entity in a flow based charging system;
obtaining, by the CRF, user information used for the charging rule selection, the user information being provided by the AF entity; and
determining, by the CRF, a charging rule for a subscriber based on the service information and user information provided by the AF.

22. The method of claim 21, wherein the user information provided by the AF comprises user identification for indicating the charging rule to be applied to a subscriber identified by the user identification.

23. The method of claim 21, wherein the user information provided by the AF comprises group identification for indicating the charging rule to be applied for the subscribers in a user group identified by the group identification.

24. The method of claim 21, wherein the user information provided by the AF comprises any combination of user identification and group identification for indicating the charging rule to be applied for a subscriber identified by the user identification in a user group identified by the group identification.

25. The method of claim 24, wherein the combination of user identification and group identification comprises a combination of one or more user identifications and one group identification, or a combination of more than one user identifications and more than one group identifications.

26. The method of claim 21, wherein the service information provided by the AF for charging rule selection comprises application/service identification, trigger event of application/service charging rule.

27. The method of claim 21, further comprising:
sending, by the CRF, the selected charging rule to a Traffic Plane Function (TPF) entity in the flow based charging system so that the TPF perform a corresponding action based on the charging rule.

28. The method of claim 27, wherein the corresponding action comprises any one or more of a charging rule creation, a charging rule deletion, and a charging rule modification.
